(19) United States
(12) Patent Application Publication
(10) Pub. No.: US 2022/0101210 A1
(43) Pub. Date: Mar. 31, 2022

(54) METHOD, SERVER, AND NON-TRANSITORY COMPUTER READABLE MEDIUM

(71) Applicant: TOYOTA JIDOSHA KABUSHIKI KAISHA, Toyota-shi (JP)

(72) Inventors: Ai MIYATA, Okazaki-shi (JP); Yurika TANAKA, Yokosuka-shi (JP); Hideo HASEGAWA, Nagoya-shi (JP); Hiroyuki SUZUKI, Miyoshi-shi (JP); Katsuhiro OHARA, Nagoya-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/488,486

(22) Filed: Sep. 29, 2021

(30) Foreign Application Priority Data
Sep. 30, 2020 (JP) 2020-166381

(51) Int. Cl. G06Q 10/02; G06Q 30/04

(52) U.S. Cl. CPC G06Q 10/02; G06Q 30/04

(57) ABSTRACT

A method performed by a server includes accepting a reservation for an unmanned aircraft in response to a request from a first user who provides a charging facility or a standby spot for the unmanned aircraft, and determining a first usage fee for the unmanned aircraft to be charged to the first user, based on actual use of the charging facility or the standby spot by the unmanned aircraft.

### CROSS-REFERENCE TO RELATED APPLICATION

This application claims priority to Japanese Patent Application No. 2020-166381, filed on Sep. 30, 2020, the entire contents of which are incorporated herein by reference.

### TECHNICAL FIELD

The present disclosure relates to a method, a server, and a non-transitory computer readable medium.

### BACKGROUND

Technology for controlling unmanned aircraft such as drones is known. For example, Patent Literature (PTL) 1 discloses a drone management system that manages drones for delivery of packages.

### CITATION LIST

### Patent Literature

PTL 1: JP 2019-131332 A

### SUMMARY

In recent years, it is desired to promote the use of service provided using unmanned aircraft, such as, for example, logistics service in which unmanned aircraft transport packages that users desire to send or receive.

It would be helpful to promote the use of service provided using unmanned aircraft.

A method according to an embodiment of the present disclosure is a method performed by a server, the method including:

accepting a reservation for an unmanned aircraft in response to a request from a first user who provides a charging facility or a standby spot for the unmanned aircraft; and

determining a first usage fee for the unmanned aircraft to be charged to the first user, based on actual use of the charging facility or the standby spot by the unmanned aircraft.

A server according to an embodiment of the present disclosure is a server including a controller configured to:

accept a reservation for an unmanned aircraft in response to a request from a first user who provides a charging facility or a standby spot for the unmanned aircraft; and

determine a first usage fee for the unmanned aircraft to be charged to the first user, based on actual use of the charging facility or the standby spot by the unmanned aircraft.

A non-transitory computer readable medium according to an embodiment of the present disclosure stores a program configured to cause a server to execute operations, the operations including:

accepting a reservation for an unmanned aircraft in response to a request from a user who provides a charging facility or a standby spot for the unmanned aircraft; and

determining a usage fee for the unmanned aircraft to be charged to the user, based on actual use of the charging facility or the standby spot by the unmanned aircraft.

According to an embodiment of the present disclosure, the use of service provided using unmanned aircraft may be promoted.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of an unmanned aircraft;

FIG. 4 is a block diagram illustrating a schematic configuration of a server;

FIG. 5 is a diagram illustrating an example of a user database;

FIG. 6 is a diagram illustrating an example of an unmanned aircraft database; and

FIG. 7 is a flowchart illustrating operations of the server.

### DETAILED DESCRIPTION

Hereinafter, an embodiment of the present disclosure will be described.

### Outline of Embodiment

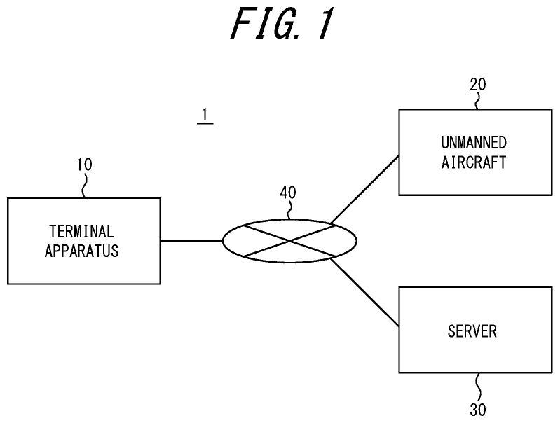

An outline of a system 1 according to an embodiment of the present disclosure will be described with reference to FIG. 1. The system 1 includes a terminal apparatus 10, an unmanned aircraft 20, and a server 30. The number of terminal apparatuses 10 and the number of unmanned aircraft 20 may each be any number not less than one.

The terminal apparatus 10 is any information processing apparatus that a user can use. For example, a general purpose apparatus such as a smartphone or a personal computer (PC) can be employed as the terminal apparatus 10.

The unmanned aircraft 20 is any aircraft without a person on board. For example, an aircraft such as a drone or a multicopter can be employed as the unmanned aircraft 20. The unmanned aircraft 20 can fly by autonomous control or by cooperation with the server 30. In the present embodiment, the unmanned aircraft 20 is used for logistics service to transport a package attached to the unmanned aircraft 20 itself to a destination. Specifically, in response to a request from a user who desires to send or receive a package, the unmanned aircraft 20 is reserved to pick up or deliver the package. The user can receive or deposit the package from or to the reserved unmanned aircraft 20. The unmanned aircraft 20 may transport a package directly from a package sender to a package recipient, from a package sender to a relay station, or from a relay station to a package recipient. However, not limited to the logistics service, the unmanned aircraft 20 can be used for any service provided using the unmanned aircraft 20.

The server 30 includes a single information processing apparatus or multiple information processing apparatuses that can communicate with each other. The server 30 can communicate with each of the terminal apparatus 10 and the unmanned aircraft 20 via a network 40 including, for example, the Internet, a mobile communication network, and the like. In the present embodiment, the unmanned aircraft 20 and the server 30 may be managed by a logistics service provider.

First, an outline of the present embodiment will be described, and details thereof will be described later. In the present embodiment, a user may provide a logistics service provider with a charging facility or a standby spot in the possession of the user, for example. The charging facility is any apparatus capable of wired or wireless charging of the unmanned aircraft 20. The standby spot is any spot at which the unmanned aircraft 20 can land to stand by during a time period when the unmanned aircraft 20 does not transport packages, for example. The server 30 accepts a reservation for the unmanned aircraft 20 in response to a request from the user who provides the charging facility or the standby spot for the unmanned aircraft 20. Then, the server 30 determines a usage fee for the unmanned aircraft 20 to be charged to the user, based on actual use of the charging facility or the standby spot by the unmanned aircraft 20.

Hence, according to the present embodiment, in a case in which a user provides a charging facility or a standby spot for the unmanned aircraft 20, a usage fee for the unmanned aircraft 20 to be charged to the user is determined based on actual use of the charging facility or the standby spot. Thus, the user can reduce the usage fee for the unmanned aircraft 20, for example, by providing the charging facility or the standby spot for the unmanned aircraft 20 to let the unmanned aircraft 20 use the charging facility or the standby spot. Therefore, the use of service provided using the unmanned aircraft 20 may be promoted.

Next, configurations of the system 1 will be described in detail.

(Configuration of Terminal Apparatus)

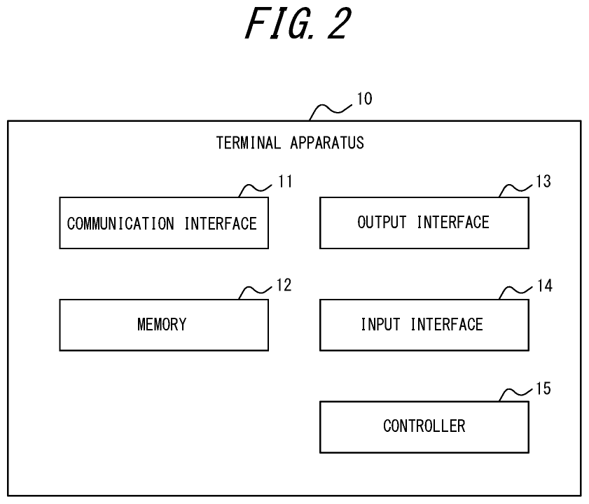

As illustrated in FIG. 2, the terminal apparatus 10 includes a communication interface 11, a memory 12, an output interface 13, an input interface 14, and a controller 15.

The communication interface 11 may include at least one communication interface for connecting to the network 40. The communication interface is compliant with mobile communication standards such as the 4th generation (4G) standard and the 5th generation (5G) standard, a wired local area network (LAN) standard, or a wireless LAN standard, for example, but not limited to these, and may be compliant with any communication standard. In the present embodiment, the terminal apparatus 10 communicates with the server 30 via the communication interface 11.

The memory 12 includes one or more memories. The memories are semiconductor memories, magnetic memories, optical memories, or the like, for example, but are not limited to these. The memories included in the memory 12 may each function as, for example, a main memory, an auxiliary memory, or a cache memory. The memory 12 stores any information used for operations of the terminal apparatus 10. For example, the memory 12 may store a system program, an application program, embedded software, and the like. The information stored in the memory 12 may be updated with, for example, information acquired from the network 40 via the communication interface 11.

The output interface 13 includes at least one output device for outputting information to notify the user of the information. The output device is a display for outputting information as video, a speaker for outputting information as audio, or the like, for example, but is not limited to these.

The input interface 14 includes at least one input device for detecting user input. The input device is a physical key, a capacitive key, a touch screen integrally provided with a display of the output interface 13, a microphone for accepting audio input, a camera, or the like, for example, but is not limited to these.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire terminal apparatus 10.

(Configuration of Unmanned Aircraft)

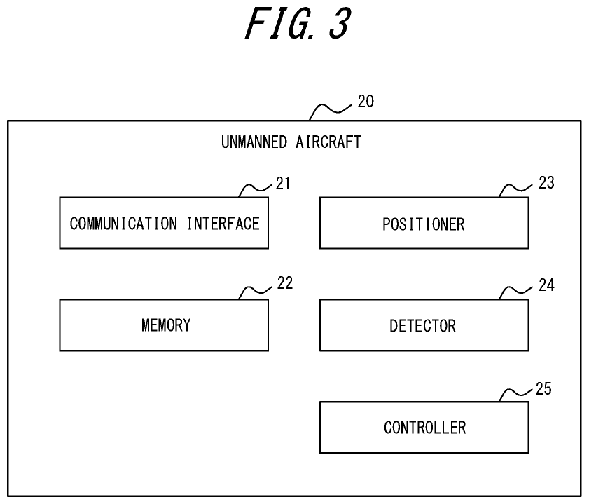

As illustrated in FIG. 3, the unmanned aircraft 20 includes a communication interface 21, a memory 22, a positioner 23, a detector 24, and a controller 25.

The communication interface 21 includes at least one communication interface for connecting to the network 40. The communication interface is compliant with mobile communication standards, for example, but not limited to these, and may be compliant with any communication standard. In the present embodiment, the unmanned aircraft 20 communicates with the server 30 via the communication interface 21.

The memory 22 includes one or more memories. The memories included in the memory 22 may each function as, for example, a main memory, an auxiliary memory, or a cache memory. The memory 22 stores any information used for operations of the unmanned aircraft 20. For example, the memory 22 may store a system program, an application program, embedded software, and the like. The information stored in the memory 22 may be updated with, for example, information acquired from the network 40 via the communication interface 21.

The positioner 23 includes a receiver compatible with a satellite positioning system. The receiver is compatible with the Global Positioning System (GPS), for example, but is not limited to this, and may be compatible with any satellite positioning system. The positioner 23 includes, for example, a gyro sensor, a geomagnetic sensor, and a barometric pressure sensor. In the present embodiment, the unmanned aircraft 20 can acquire, using the positioner 23, position information for the unmanned aircraft 20 itself, a direction toward which the unmanned aircraft 20 itself is directed, and a tilt of the unmanned aircraft 20 itself. The position information may include two-dimensional coordinate data including latitude and longitude, or three-dimensional coordinate data including altitude, in addition to latitude and longitude.

The detector 24 includes at least one sensor used for detecting obstacles present around the unmanned aircraft 20. The sensor is, for example, a camera, a millimeter wave radar, a Light Detection and Ranging (LiDAR) sensor, or the like, but is not limited to these. Output information from the sensor of the detector 24 may be used to help the unmanned aircraft 20 navigate around the surrounding obstacles, for example.

The controller 25 includes at least one processor, at least one programmable circuit, at least one dedicated circuit, or a combination of these. The controller 25 controls the operations of the entire unmanned aircraft 20.

(Configuration of Server)

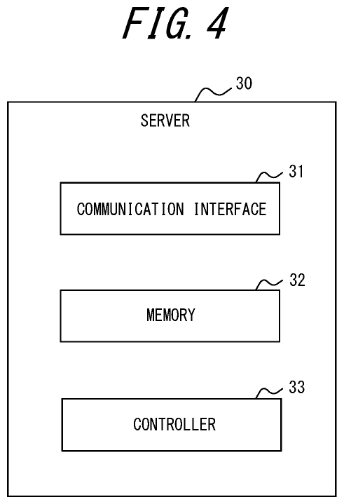

As illustrated in FIG. 4, the server 30 includes a communication interface 31, a memory 32, and a controller 33.

The communication interface 31 includes at least one communication interface for connecting to the network 40. The communication interface is compliant with a wired LAN standard or a wireless LAN standard, for example, but is not limited to these, and may be compliant with any communication standard. In the present embodiment, the server 30 communicates with the terminal apparatus 10 and the unmanned aircraft 20 via the communication interface 31.

The memory 32 includes one or more memories. The memories included in the memory 32 may each function as, for example, a main memory, an auxiliary memory, or a cache memory. The memory 32 stores any information used for operations of the server 30. For example, the memory 32 may store a system program, an application program, a database, map information, and the like. The information stored in the memory 32 may be updated with, for example, information acquired from the network 40 via the communication interface 31.

In the present embodiment, the memory 32 stores a user database and an unmanned aircraft database.

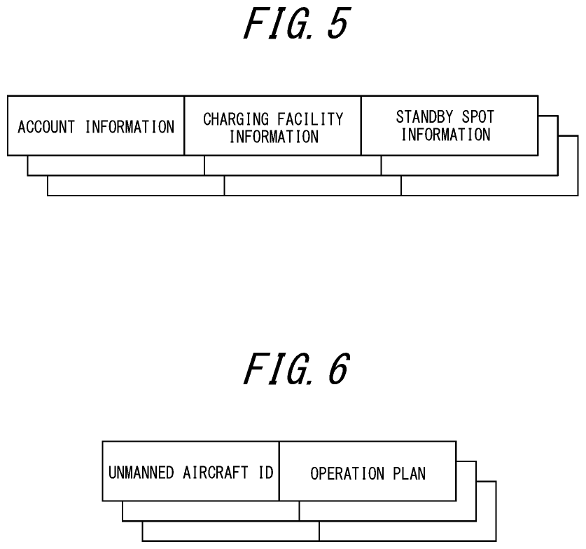

As illustrated in FIG. 5, the user database includes user data having “account information”, “charging facility information”, and “standby spot information” for each user.

“Account information” includes any information regarding a user. The account information may include a login ID and a password for logging in to service, biological information, a user ID, a username, payment information used for electronic payment such as bank account information or credit card information, and the like, for example, but is not limited to these. The account information may also be used to authenticate a package sender or a package recipient when, for example, an unmanned aircraft 20 picks up or delivers a package.

“Charging facility information” includes any information regarding a charging facility provided by a user. The charging facility information may include position information for the charging facility, an available time period, an electricity rate of electric power supplied by the charging facility, information indicating whether the electric power supplied by the charging facility is generated from renewable energy or depletable energy, and the like, for example, but is not limited to these. The charging facility information for a user who provides no charging facility may be blank.

“Standby spot information” includes any information regarding a standby spot provided by a user. The standby spot information may include position information for the standby spot, an available time period, the number of unmanned aircraft 20 that the standby spot can accommodate, the presence or absence of a roof, a land price of an area in which the standby spot is located, and the like, for example, but is not limited to these. The standby spot information for a user who provides no standby spot may be blank.

As illustrated in FIG. 6, the unmanned aircraft database includes unmanned aircraft data having an “unmanned aircraft ID” and an “operation plan” for each unmanned aircraft 20.

An “unmanned aircraft ID” is information that can uniquely identify an unmanned aircraft 20.

An “operation plan” includes any information regarding transport of packages by an unmanned aircraft 20. The operation plan may include a time period during which the unmanned aircraft 20 transports a package, a flight path during the time period, a location where the package is delivered and received between a package sender or a package recipient and the unmanned aircraft 20, a user ID of the package sender or the package recipient, a time period during which the unmanned aircraft 20 uses a charging facility or a standby spot provided by a user, electrical energy supplied by the charging facility to the unmanned aircraft 20, and the like, for example, but is not limited to these.

The controller 33 illustrated in FIG. 4 includes at least one processor, at least one programmable circuit, at least one dedicated circuit, or a combination of these. The controller 33 controls the operations of the entire server 30. Details of the operations of the server 30 controlled by the controller 33 will be described later.

(Flow of Operations of Server)

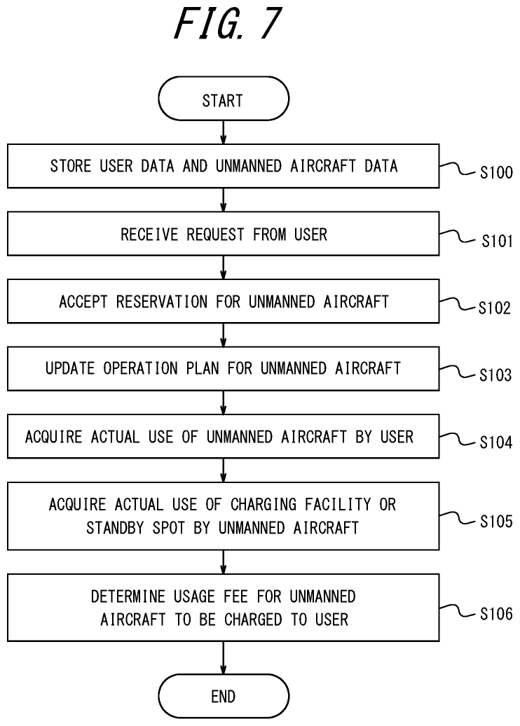

Operations of the server 30 according to the present embodiment will be described with reference to FIG. 7.

Step S100: The controller 33 of the server 30 stores user data and unmanned aircraft data in the memory 32.

Step S101: The controller 33 receives a request from a user who is a package sender or a package recipient.

Specifically, the controller 33 receives information indicating a request from a user for delivery of a package from the terminal apparatus 10 via the communication interface 31. The information may include, for example, a user ID of the user, information indicating a date and time, a place, and the like at which the user is to receive or deposit the package from or to an unmanned aircraft 20, and the like, but is not limited to these, and may include information indicating any request from the user for delivery of the package.

Step S102: The controller 33 accepts a reservation for an unmanned aircraft 20 that can respond to the request of step S101.

Specifically, the controller 33, upon identifying an unmanned aircraft 20 that can respond to the request of step S101 by referring to the operation plans included in the unmanned aircraft database, accepts a reservation for the unmanned aircraft 20.

Step S103: The controller 33 updates the corresponding operation plan for the unmanned aircraft 20 for which the reservation has been accepted in step S102. Specifically, the controller 33 updates the corresponding operation plan for the unmanned aircraft 20 so that the unmanned aircraft 20 delivers or receives the package to or from the user in accordance with the request of step S101.

Each time step S101 described above is performed (i.e., each time the server 30 receives a request from a user), steps S102 and S103 are performed. On the other hand, steps S104 to S106 described next are periodically performed at predetermined time intervals.

Step S104: The controller 33 acquires actual use of the unmanned aircraft 20 by the user with reference to the corresponding operation plan in the unmanned aircraft database. The actual use of the unmanned aircraft 20 by the user may include, for example, the total number of times the unmanned aircraft 20 has been used or the total amount of time for which the unmanned aircraft 20 has been used in the most recent period.

Step S105: The controller 33 acquires actual use, by the unmanned aircraft 20, of a charging facility or a standby spot provided by the user with reference to the corresponding operation plan in the unmanned aircraft database. The actual use of the charging facility or the standby spot by the unmanned aircraft 20 may include, for example, the total electrical energy supplied by the charging facility to the unmanned aircraft 20 or the total amount of standby time taken by the unmanned aircraft 20 at the standby spot in the most recent period.

Step S106: The controller 33 determines a usage fee for the unmanned aircraft 20 to be charged to the user, based on at least one of the actual use of the unmanned aircraft 20 by the user acquired in step S104 or the actual use of the charging facility or the standby spot by the unmanned aircraft 20 acquired in step S105.

Any method can be employed to determine the usage fee. For example, the controller 33 may determine, based on the actual use of the unmanned aircraft 20 by the user, the usage fee to be lower as the unmanned aircraft 20 has been used a fewer number of times in total or the unmanned aircraft 20 has been used for a shorter amount of time in total.

For example, the controller 33 may determine, based on the actual use of the charging facility by the unmanned aircraft 20, the usage fee to be lower as more electrical energy has been supplied by the charging facility to the unmanned aircraft 20 in total. The controller 33 may determine, based on the actual use of the charging facility by the unmanned aircraft 20, the usage fee to be lower in a case in which electric power supplied by the charging facility used by the unmanned aircraft 20 is generated from renewable energy than in a case in which the electric power is generated from depletable energy.

For example, the controller 33 may determine, based on the actual use of the standby spot by the unmanned aircraft 20, the usage fee to be lower as a longer amount of standby time has been taken by the unmanned aircraft 20 at the standby spot in total. The controller 33 may determine the usage fee based on the actual use of the standby spot by the unmanned aircraft 20 and position information for the standby spot. Specifically, the controller 33 may determine the usage fee to be lower in a case in which the standby spot used by the unmanned aircraft 20 is located in a first area than in a case in which the standby spot is located in a second area whose land price is lower than that of the first area.

As described above, the server 30 according to the present embodiment accepts a reservation for an unmanned aircraft 20 in response to a request from a user who provides a charging facility or a standby spot for the unmanned aircraft 20. Then, the server 30 determines a usage fee for the unmanned aircraft 20 to be charged to the user, based on actual use of the charging facility or the standby spot by the unmanned aircraft 20.

According to such a configuration, in a case in which a user provides a charging facility or a standby spot for an unmanned aircraft 20, a usage fee for the unmanned aircraft 20 to be charged to the user is determined based on actual use of the charging facility or the standby spot. Thus, the user can reduce the usage fee for the unmanned aircraft 20, for example, by providing the charging facility or the standby spot for the unmanned aircraft 20 to let the unmanned aircraft 20 use the charging facility or the standby spot. Therefore, the use of service provided using the unmanned aircraft 20 may be promoted.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, an embodiment in which the configuration and operations of the server 30 are distributed to multiple information processing apparatuses that can communicate with each other can be implemented.

In the embodiment described above, the controller 33 of the server 30 may determine a first usage fee to be lower than a second usage fee, the first usage fee being charged to a first user who provides a charging facility or a standby spot and the second usage fee being charged to a second user who does not provide either a charging facility or a standby spot.

For example, an embodiment in which a general purpose computer functions as the server 30 according to the embodiment described above can also be implemented. Specifically, a program in which processes for realizing the functions of the server 30 according to the embodiment described above are written is stored in a memory of a general purpose computer, and the program is read and executed by a processor. Accordingly, the present disclosure can also be implemented as a program executable by a processor, or a non-transitory computer readable medium storing the program.

1. A method performed by a server, the method comprising:
accepting a reservation for an unmanned aircraft in response to a request from a first user who provides a charging facility or a standby spot for the unmanned aircraft; and
determining a first usage fee for the unmanned aircraft to be charged to the first user, based on actual use of the charging facility or the standby spot by the unmanned aircraft.

2. The method according to claim 1, wherein
the actual use of the charging facility by the unmanned aircraft includes electrical energy supplied by the charging facility to the unmanned aircraft, and
the first usage fee is determined to be lower as more electrical energy has been supplied by the charging facility to the unmanned aircraft.

3. The method according to claim 2, wherein the first usage fee is determined to be lower in a case in which electric power supplied by the charging facility is generated from renewable energy than in a case in which the electric power supplied by the charging facility is generated from depletable energy.

4. The method according to claim 1, wherein
the actual use of the standby spot by the unmanned aircraft includes an amount of standby time taken by the unmanned aircraft at the standby spot, and
the first usage fee is determined to be lower as a longer amount of standby time has been taken by the unmanned aircraft at the standby spot.

5. The method according to claim 1, wherein the first usage fee is determined based on the actual use of the standby spot by the unmanned aircraft and position information for the standby spot.

6. The method according to claim 5, wherein the first usage fee is determined to be lower in a case in which the standby spot is located in a first area than in a case in which the standby spot is located in a second area whose land price is lower than that of the first area.

7. The method according to claim 1, further comprising:
accepting a reservation for the unmanned aircraft in response to a request from a second user who does not provide either a charging facility or a standby spot for the unmanned aircraft; and
determining a second usage fee for the unmanned aircraft to be charged to the second user, wherein
the first usage fee is determined to be lower than the second usage fee.

8. A server comprising a controller configured to:
accept a reservation for an unmanned aircraft in response to a request from a first user who provides a charging facility or a standby spot for the unmanned aircraft; and
determine a first usage fee for the unmanned aircraft to be charged to the first user, based on actual use of the charging facility or the standby spot by the unmanned aircraft.

9. The server according to claim 8, wherein
the actual use of the charging facility by the unmanned aircraft includes electrical energy supplied by the charging facility to the unmanned aircraft, and
the first usage fee is determined to be lower as more electrical energy has been supplied by the charging facility to the unmanned aircraft.

10. The server according to claim 9, wherein the first usage fee is determined to be lower in a case in which electric power supplied by the charging facility is generated from renewable energy than in a case in which the electric power supplied by the charging facility is generated from depletable energy.

11. The server according to claim 8, wherein
the actual use of the standby spot by the unmanned aircraft includes an amount of standby time taken by the unmanned aircraft at the standby spot, and
the first usage fee is determined to be lower as a longer amount of standby time has been taken by the unmanned aircraft at the standby spot.

12. The server according to claim 8, wherein the first usage fee is determined based on the actual use of the standby spot by the unmanned aircraft and position information for the standby spot.

13. The server according to claim 12, wherein the first usage fee is determined to be lower in a case in which the standby spot is located in a first area than in a case in which the standby spot is located in a second area whose land price is lower than that of the first area.

14. The server according to claim 8, wherein the controller is configured to:
accept a reservation for the unmanned aircraft in response to a request from a second user who does not provide either a charging facility or a standby spot for the unmanned aircraft; and
determine a second usage fee for the unmanned aircraft to be charged to the second user, wherein
the first usage fee is determined to be lower than the second usage fee.

15. A non-transitory computer readable medium storing a program configured to cause a server to execute operations, the operations comprising:
accepting a reservation for an unmanned aircraft in response to a request from a user who provides a charging facility or a standby spot for the unmanned aircraft; and
determining a usage fee for the unmanned aircraft to be charged to the user, based on actual use of the charging facility or the standby spot by the unmanned aircraft.

16. The medium according to claim 15, wherein
the actual use of the charging facility by the unmanned aircraft includes electrical energy supplied by the charging facility to the unmanned aircraft, and
the usage fee is determined to be lower as more electrical energy has been supplied by the charging facility to the unmanned aircraft.

17. The medium according to claim 16, wherein the usage fee is determined to be lower in a case in which electric power supplied by the charging facility is generated from renewable energy than in a case in which the electric power supplied by the charging facility is generated from depletable energy.

18. The medium according to claim 15, wherein
the actual use of the standby spot by the unmanned aircraft includes an amount of standby time taken by the unmanned aircraft at the standby spot, and
the usage fee is determined to be lower as a longer amount of standby time has been taken by the unmanned aircraft at the standby spot.

19. The medium according to claim 15, wherein the usage fee is determined based on the actual use of the standby spot by the unmanned aircraft and position information for the standby spot.

20. The medium according to claim 19, wherein the usage fee is determined to be lower in a case in which the standby spot is located in a first area than in a case in which the standby spot is located in a second area whose land price is lower than that of the first area.
